(19) United States
(12) Patent Application Publication
(10) Pub. No.: US 2026/0057093 A1
(43) Pub. Date: Feb. 26, 2026

(54) PROTECTING AN INPUT DATASET AGAINST LINKING WITH FURTHER DATASETS

(71) Applicant: Cyber Security Research Centre Limited, Joondalup (AU)

(72) Inventors: Chamikara Arachchige, Joondalup (AU); Sushmita Ruj, Joondalup (AU); Ian Opperman, Joondalup (AU); Dongxi Liu, Joondalup (AU); Seung Jang, Joondalup (AU); Arindam Pal, Joondalup (AU); Meisam Mohammady, Joondalup (AU); Roberto Musotto, Joondalup (AU); Sevit Cemtepe, Joondalup (AU); Surya Nepal, Joondalup (AU)

(73) Assignee: Cyber Security Research Centre Limited, Joondalup (AU)

(21) Appl. No.: 19/103,749

(22) PCT Filed: Sep. 29, 2023
(86) PCT No.: PCT/AU2023/050945

§ 371 Date: Feb. 13, 2025

(30) Foreign Application Priority Data
Sep. 30, 2022 (AU) 2022902837

(51) Int. Cl. G06F 21/62

(52) U.S. Cl. CPC G06F 21/6218

(57) ABSTRACT

This disclosure relates to protecting an input dataset against linking with further datasets. A processor of a computer system calculates multiple values of one or more parameters of a perturbation function, the perturbation function being configured to perturb the input dataset to protect the input dataset against linking with further datasets, each of the multiple values of the one or more parameters of the perturbation function indicating a level of protection against linking with further datasets. The processor then generates multiple derived datasets from the input dataset and calculates, for each of the multiple derived datasets, a utility score that is indicative of a utility of the derived dataset for a desired data analysis. The processor then outputs one of the multiple derived datasets that has the highest utility score.

### CROSS-REFERENCE TO RELATED APPLICATIONS

The present application claims priority from Australian Provisional Patent Application No 2022902837 filed on 30 Sep. 2022, the contents of which are incorporated herein by reference in their entirety.

### TECHNICAL FIELD

This disclosure relates to protecting an input dataset against linking with further datasets.

### BACKGROUND

An increasing amount of data is being collected by various different entities but that data is often not utilised optimally because it remains within the collecting entities. It would be advantageous if data from different entities could be combined. However, what stands in the way of sharing datasets is that it is often possible to link datasets so that information can be obtained even if that information has been kept secure at the respective entity and was not shared. In other words, linking of datasets can lead to a discovery of data that was meant to be kept secured against access from unauthorised parties.

For example, government agencies are under an obligation to share collected data for the public good. On the other hand, government agencies have data on individuals that must be kept secure. It is difficult for government agencies, or other data collecting entities, to share some data while ensuring that the data that is not shared remains protected. In particular, it is difficult to protect the shared data against linking with other datasets that would reveal the shared data, such as by re-identification.

For example, a tax office may have an income database containing fields for name, postcode, occupation and income of individuals. The tax office decides to remove the name field and publishes the remaining data for occupation, postcode and income as “de-identified data”. However, there may be only one surgeon in a particular postcode and a separate doctors dataset contains names of surgeons for specific postcodes. Therefore, it is possible to link the two datasets, that is, find one or more fields where values match exactly, which is the postcode in this example. The result is a name of a surgeon from the doctors dataset uniquely linked with the income from the tax dataset. Therefore, this linking reveals the exact income of a particular individual although that information has been withheld by the tax office. It is difficult to determine how to share a dataset while protecting it from linking with other datasets.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

This disclosure provides systems and methods that protect an input dataset from linking with further datasets. This is achieved by perturbing the input dataset multiple times with multiple different perturbation parameters to generate multiple perturbed datasets that each satisfy a given protection against linking. The disclosed systems and methods then select the perturbed dataset that has the highest utility for a specific purpose. While this approach results in the most useful dataset under a given protection against linking, it also improves computational efficiency because the number of randomisations is reduced. More particularly, randomising a dataset to a high degree means that a large amount of computing power is used to perturb the dataset. However, with the disclosed solution, the dataset is randomised to a lower degree which reduces the amount of required computing resources significantly.

A computer-implemented method for protecting an input dataset against linking with further datasets comprises:
calculating multiple values of one or more parameters of a perturbation function, the perturbation function being configured to perturb the input dataset to protect the input dataset against linking with further datasets, each of the multiple values of the one or more parameters of the perturbation function indicating a level of protection against linking with further datasets:
generating multiple derived datasets from the input dataset, wherein
   each of the multiple derived datasets are generated by applying the perturbation function to the input dataset, and
   each of the multiple derived datasets are generated by using a different one of the multiple values of the one or more parameters of the perturbation function:
calculating, for each of the multiple derived datasets, a utility score that is indicative of a utility of the derived dataset for a desired data analysis; and
outputting one of the multiple derived datasets that has the highest utility score.

In some embodiments, the method further comprises receiving a request for the dataset from a requestor; and the level of protection is based on one or more of the requestor or data in the request.

In some embodiments, calculating the multiple values of the one or more parameters of the perturbation function is based on a factor (PIF) indicative of linkability of the input dataset.

In some embodiments, method further comprises calculating multiple cell surprise factors (CSF), each CSF representing an attribute's indistinguishability within the input dataset; and calculating the factor indicative of linkability of the input dataset by combining the multiple CSFs.

In some embodiments, the method further comprises partitioning the input dataset into a first partition of quasi-identifiers and a second partition of sensitive data; wherein the perturbation function is applied only to the second partition.

In some embodiments, the method further comprises calculating the factor indicative of linkability for the second partition including one attribute of the first partition: based on the calculated factor, selectively adding the one attribute of the first partition to the second partition: wherein the perturbation function is applied only to the second partition including selectively added attributes from the first partition.

In some embodiments, the method further comprises performing fuzzy interference using the factor indicative of linkability of the input dataset to determine the multiple values of the one or more parameters.

In some embodiments, performing the fuzzy interference is based on a fuzzy membership function for each of the factor indicative of the linkability and the one or more parameters of the perturbation function.

In some embodiments, linkability is measured in terms of differential ε, δ privacy and the one or more parameters of the perturbation function are ε and δ.

In some embodiments, the method further comprises removing identifier attributes from the input dataset.

In some embodiments, calculating the utility score comprises calculating a distribution difference between the input dataset and the derived dataset; and outputting the one of the multiple derived datasets that has the highest distribution difference.

In some embodiments, calculating the utility score comprises calculating an accuracy of the desired data analysis on the derived dataset; and outputting the one of the multiple derived datasets that has the highest accuracy.

In some embodiments, the method further comprises applying a threat model to the derived dataset that has the highest utility score and assessing the similarity between tuples of the input dataset and the derived dataset; and selectively blocking the outputting based on the assessing the similarity.

In some embodiments, calculating the utility score is based on a utility loss and a privacy leak.

In some embodiments, the utility score is a weighted sum of utility loss and privacy leak.

In some embodiments, the method selectively blocks outputting the derived dataset upon determining that the weighted sum of utility loss and privacy leak is above a predetermined threshold.

Software, when executed by a computer, causes the computer to perform the above method.

A computer system comprising a processor is programmed to perform the above method.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

An example will be described with reference to the following drawings:

FIG. 1 illustrates a flowchart of aspects of this disclosure, according to an embodiment.

FIG. 2a illustrates a method for protecting an input dataset against linking with further datasets, according to an embodiment.

FIG. 2b illustrates a computer system for protecting an input dataset against linking with further datasets, according to an embodiment.

FIGS. 3a, 3b and 3c illustrates the mapping between the three fuzzy variables and the change of personal information factor (PIF) against the changes of δ and ε, according to an embodiment.

FIGS. 4a and 4b illustrate examples of an algorithm for generating a privacy-preserving dataset according to an embodiment.

FIGS. 5a, 5b, 5c and 5d—The cell surprise factor (CSF) and PIF analysis of the input dataset and the CSF and PIF analysis of the Q attributes, according to an embodiment. More particularly, FIG. 5a illustrates CSF analysis on the input dataset. FIG. 5b illustrates PIF analysis on the input dataset. The light bars (first, seventh, 10^{th}, 12^{th}) represent the Q attributes. FIG. 5c illustrates CSF analysis on the Q attributes. FIG. 5d illustrates PIF analysis on the Q attributes.

FIGS. 6a and 6b—The CSF and PIF analysis of the refined set of Q attributes, according to an embodiment. FIG. 6a illustrates CSF analysis on the refined set of Q attributes. FIG. 6b illustrates PIF analysis on the refined set of Q attributes.

FIGS. 7a, 7b and 7c-A comparison between utility and effectiveness of the privacy-preserving datasets generated by the disclosed methods, according to an embodiment. FIG. 7a illustrates the results of an utility analysis on privacy preserving datasets. FIG. 7b illustrates the results of an effectiveness analysis on the privacy preserving datasets.

FIGS. 8a and 8b-A comparison between utility and effectiveness of the privacy pre-serving datasets without Q attribute refinement, according to an embodiment. FIG. 8a illustrates results of a utility analysis on privacy-preserving datasets without Q attribute refinement. FIG. 8b illustrates results of an effectiveness analysis on the privacy preserving without Q attribute refinement.

FIG. 9 illustrates a server implementation according to an embodiment.

FIG. 10 illustrates configuration data for implementing the disclosed methods according to an embodiment.

### DESCRIPTION OF EMBODIMENTS

Sharing data linked with personally identifiable information (PII) can lead to the leak of sensitive personal information through linking with further datasets in order to re-identify datasets that have been de-identified before sharing: hence, introducing potential threats to user privacy. Throughout this disclosure, linkage or linking means the use of any external data to infer information about individual rows. For example, re-identification using external data is an example of linking a dataset with further datasets.

Differential privacy is an example disclosure control mechanism, due to its strict privacy guarantees. An algorithm M satisfies differential privacy, if for all neighboring datasets x and y, and all possible outputs, S, Pr[M(x)∈S]≤exp(ε)Pr[M(y)εS]+δ, where, ε is called the privacy budget, denotes the privacy leak, whereas δ represents the probability of model failure.

In a similar notation, it can be said that for a mechanism to satisfy (ε, δ)-differential privacy, it would satisfy the below Equation, where d, and d′ are datasets differing by one record. That is, a randomized algorithm M with domain [symbol] and range R: is (ε, δ)-differentially private for δ≥0 if for every adjacent datasets d, d′ ∈ [symbol] and for any subset S⊆R.

$$P [ M ( d ) ∈ S ] \leq {e}^{ε} P [ M ( {d}^{′} ) ∈ S ] + δ$$

In some examples, tabular data sharing is considered because tabular data is often shared among different agencies or published for public use or interaction with a particular agency. This disclosure focuses on privacy and utility of tabular data sharing with DP (also referred to as non-interactive data sharing); where privacy level is quantified using DP and utility is quantified using U(D), the application-specific utility (e.g. accuracy, precision) of running an application, A on D. In a tabular dataset, each row represents an individual (data owner), and the columns represent the features that are considered under the corresponding set of data owners in the table. Besides, in some examples, it may be assumed that every row is independent (belongs to only one owner) and not linked to any other row (such as trajectory data).

Non-interactive data sharing has been a significant challenge due to the extreme levels of randomization necessary to maintain enough privacy (acceptable & values) during data sharing, consequently resulting in low utility generated from the private data shared (e.g. perturbed tabular data) and excessive required computing resources. Despite being complex and challenging, non-interactive data sharing is useful to enable a wide variety of opportunities from the entire dataset being available for analysis for analysts; hence, the application at hand (e.g. classification, regression, descriptive statistics) is not constrained to a single output (e.g. mean).

Selection of the best DP approach for differentially private non-interactive data sharing faces several challenges. A few of these challenges include the diversity of input datasets (e.g. statistical properties, dimensions), the diversity of different types of applications at hand (e.g. data clustering, deep learning), the possibility of unanticipated privacy leaks due to the full dataset being released. Besides, there is no framework-based solution that allows a DP approach to be evaluated for its performance towards non-interactive data sharing with high utility and high privacy under strict privacy guarantees.

In some cases, there are unanticipated data leaks due to the relaxation of privacy constraints (ε and δ) in achieving high utility. Besides, DP non-interactive data sharing with a part of the dataset (a carefully selected set of attributes) being released for mandated reasons has not been investigated before. This problem might be of importance in a real-world scenario such as employed in a cross-agency data sharing setting. The availability of a non-perturbed vertical partition in the final dataset will provide improved utility for applications based on custom queries and reduce required computational resources.

However, this type of setting uses a greater depth of critical analysis in terms of privacy and attack resilience. This problem is referred to as controlled partially perturbed non-interactive data sharing-CPNDS). Hence, a framework that facilitates CPNDS in an application-specific utility and privacy-preserving manner is desirable. The challenges in CPNDS include (1) the availability of a range of complex dynamics (e.g. categorical/non-categorical attributes, IID data, non-IID) of input data (2) maintenance of utility of the output dataset for different types of applications demanded by the analysts, (3) maintaining a balance between privacy and utility (enabling high utility while privacy is maintained at a higher level).

This disclosure provides a unified multi-criterion-based solution to identify the best-perturbed instance of an input dataset under CPNDS. In some embodiments, the disclosed method runs under a central authority (e.g. Government agency, hospital, bank) with complete ownership and controllability to the input datasets before releasing a privacy preserving version of it. The proposed work tries to identify the best version of the perturbed instances that can be released for analytics by considering a fine-tuned set of systematic steps, which include:
1. Identifying and partitioning the types of attributes based on the privacy requirements.
2. Determining the levels of privacy necessary based on the properties of the input dataset.
3. Generating multiple randomized versions of the input dataset
4. Identifying the best-perturbed version for release based on utility, privacy, and linkability constraints.

The empirical results show that the disclosed method guarantees that the final perturbed dataset provides enough utility and privacy and properly balances them by executing the above four steps.

### Differential Privacy

Differential privacy (DP) provides a mechanism to bound the privacy leak using two parameters of a perturbation function ε (epsilon—also called the privacy budget) and δ (delta). The values to these parameters determine the strength of privacy, i.e. protection against linking that dataset with further datasets, enforced by a randomization (perturbation) algorithm (a DP mechanism-M) over a particular dataset (D). ε provides an insight into how much privacy loss is incurred during the release of a dataset. Hence, ε should be kept at a lower level, and maintaining it within the range of 0<ε≤9 (below 10-double digits), for example. δ defines the probability of model failure. For example, when δ=1/100×n, the chance of failure is 1%. Hence, δ should be kept at extremely low levels.

### The Definition of Differential Privacy

Take dataset, D, and two of its adjacent datasets, x and y (differs by one record/person). Assume x and y are collections of records from a universe χ and N denotes the set of all non-negative integers including zero. Then M satisfies (ε, δ)-differential privacy if Equation (1) holds.

Definition 1 A randomized algorithm M with domain [symbol] and range R: is (ε, δ)-differentially private for δ≥0 if for every adjacent datasets x, y∈ [symbol] and for any subset S⊆R.

$$Pr [ M ( x ) ∈ S ] \leq exp ( ε ) Pr [ M ( y ) ∈ S ] + δ \qquad ( 1 )$$

### Postprocessing Invariance Property of DP

Postprocessing invariance/robustness is the DP algorithm's ability to maintain robustness against any additional computation on its outputs. Any additional computation/processing on the outputs will not weaken its original privacy guarantee; hence, any outcome of postprocessing on an ε-DP output remains to be ε-DP.

### Fuzzy Inference Systems

In some examples, the disclosed methods utilize fuzzy logic to derive the potential list of ε, δ combinations for a prior definition of privacy requirements by an input dataset. That is, the methods calculate multiple values of the parameters ε, δ of the perturbation function. Other ways than fuzzy logic can be used to calculate the multiple values, such as decision trees, algebraic models, regression models and others.

A fuzzy inference system-FIS (fuzzy model) is derived by employing three steps sequentially: (1) fuzzification, (2) rule evaluation, and (3) defuzzification. Fuzzification is the process of mapping a crisp input into a fuzzy value. For example, a particular input such as temperature=10° C. can be mapped into the fuzzy membership of cold, producing a membership value ranging from 0 to 1. Next, the different levels of fuzzy memberships values produced by the inputs should be matched to a fuzzy output domain. This is done through the rule evaluation of the rule base of the FIS. A fuzzy inference system is composed of a list of linguistic (called the rule base) rules that enable the evaluation of different fuzzy membership levels produced during the fuzzification process. Defuzzification is the process of utilizing rule-evaluation and the aggregated membership degrees in the output parameter into a quantifiable crips output. The final crisp value is produced by applying a mechanism such as the center of gravity method (given in Equation 2) on the shape generated by the different membership levels of the output parameter.

$$COG = \frac{{\int }_{min}^{max} {μ}_{x} xdx}{{\int }_{min}^{max} {μ}_{x} dx} \qquad ( 2 )$$

### Framework

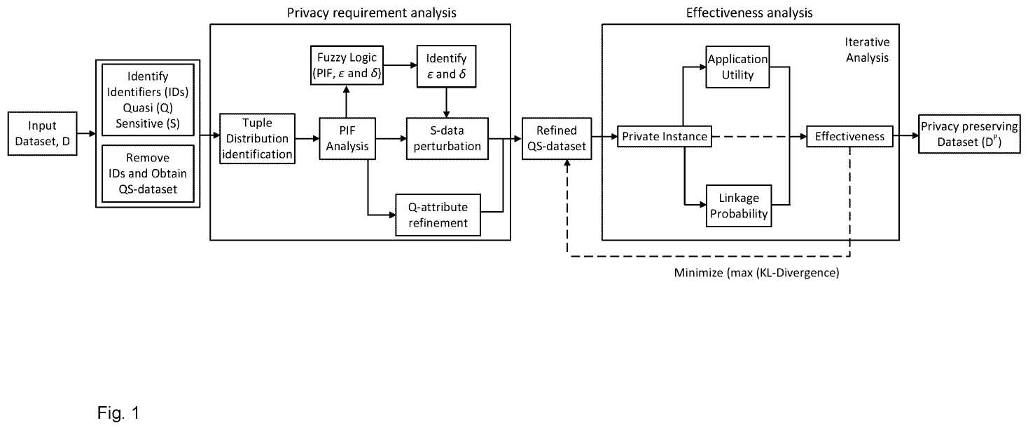

FIG. 1 shows the primary modules (represented by squares) of the disclosed framework and implemented as software modules, where arrows represent the data flow directions. In some examples, the method is controlled by a central party (e.g. Government agency, hospital, bank) with complete ownership and controllability to the datasets. A user role management over the access on functionalities may be employed. However, in this example, the data curator has full access to the dataset at hand and the functionality of the algorithm in generating a privacy-preserving dataset.

### Problem Definition

Suppose D is a dataset that is composed of n tuples (rows) and m attributes (columns). Define S-dataset to be the vertical partition of D that contains r∈m sensitive attributes. Take Dᵣ to be the S-dataset and the vertical partition of (m−r) to be D₍ₘ₋ᵣ₎. Use a differentially private algorithm (i.e. “perturbation function”) M to perturb Dᵣ and produce

$${D}_{r}^{p}$$

with n tuples a r attributes. Since

$${D}_{r}^{p}$$

is a differentially private version of Dᵣ, the privacy (i.e. protection against linking) of

$${D}_{r}^{p}$$

is constrained by the privacy parameters (e.g. privacy budget) used for M. Next a composition (D^{P}) of

$${D}_{r}^{p}$$

and D₍ₘ₋ᵣ₎ is released. This process raises the following questions.
1. How to separate the sensitive and non-sensitive attributes?
2. How to define the privacy requirements of D?
3. Can M maintain the data distribution in D?
4. How to select the privacy limits (ε and δ)?
5. Does D^{P} provide the optimal utility for a particular application?
6. What is the privacy of the entire dataset (D^{P})?

This disclosure provides a unified framework-based approach that effectively answers all these questions.

### The Proposed Solution

In one example, the dataset contains only non-categorical data. Take D to be the input dataset with mxn attributes (with m attributes and n tuples). The disclosed method automatically identifies the list of identifier attributes (ID) and quasi-attributes (Q). To protect against direct identification, the identifiers (ID attributes) are removed from the dataset. The dataset intended for publication after perturbation is formed by combining Q and the remaining vertical partition S, referred to as the QS-dataset.

### Method

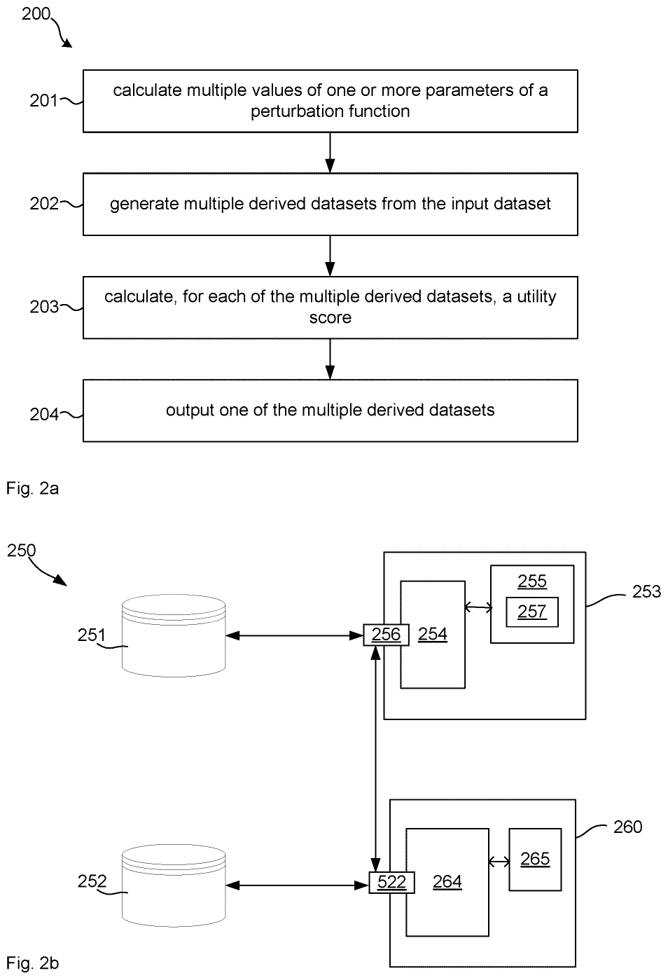

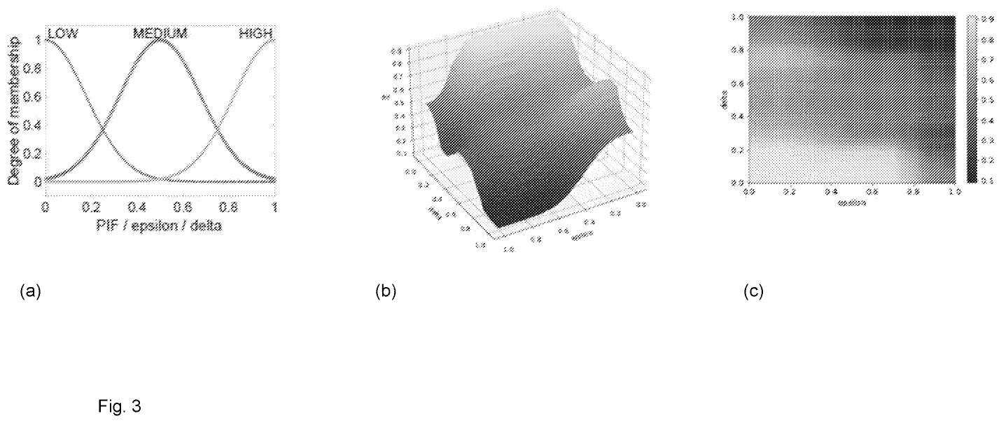

FIG. 2a illustrates a computer-implemented method 200 for protecting an input dataset against linking with further datasets. As set out above, this means protecting the dataset against linking individual rows with further datasets that enable identification of individuals of those rows, for example. While some examples herein are provided with reference to users and confidentiality of user data (such as patient data), the methods disclosed herein are equally applicable to other types of data. For example, it may be desirable to share operational machine parameters, such as aircraft turbine temperature, but protecting this information against linking to further turbine data that would allow the identification of individual turbines. The method can be implemented as software and executed by a processor of a computer system, which causes the processor to perform the steps of method 200.

In that sense, the processor calculates 201 multiple values of one or more parameters (e.g., ε, δ) of a perturbation function (M). The perturbation function is configured to perturb the input dataset to protect the input dataset against linking with further datasets. The multiple values of the parameters of the perturbation function indicate a level of protection against linking with further datasets. It is noted that there is no one-to-one relationship between the desired level of protection and the ε, δ. In other words, there may be multiple ε, δ value pairs that provide the same, or substantially the same, level of protection against linking. It is now the question how to select one of the value pairs out of the seemingly equivalent candidates.

To address this issue, the processor generates 202 multiple derived datasets from the input dataset for the different ε, δ value pairs. This means each of the multiple derived datasets are generated by applying the perturbation function to the input dataset, and each of the multiple derived datasets are generated by using a different one of the multiple values of the ε, δ parameters of the perturbation function.

The processor the calculates 203, for each of the multiple derived datasets, a utility score that is indicative of a utility of the derived dataset for a desired data analysis as described below. Finally, the processor outputs 204 one of the multiple derived datasets that has the highest utility score.

FIG. 2b illustrates a computer system 250 for protecting an input dataset 251 against linking with further datasets 252. It is noted that in some examples, the input dataset 251 comprises tabular data comprising rows and columns, such as data stored in a relational database including SQL, Oracle or others. The further dataset 252 may also be tabular data stored in a relational database but may also be stored in other forms. In particular, further dataset 252 may not be stored as rows and columns and may comprise only a small amount of information. For example, further dataset 252 may comprise only a single piece of information, such as a single record that can be linked with one or more rows of the input dataset 251. This may enable re-identification of a row from input dataset if the input dataset is not sufficiently protect against linkage.

Computer system 250 comprises a custodian computer 253 having a processor 254, program memory 255 and a communication port 256. The program memory 255 is a non-transitory computer readable medium, such as a hard drive, a solid state disk or CD-ROM. Software, that is, an executable program stored on program memory 255 causes the processor 254 to perform the method in FIG. 2a, that is, calculates multiple parameters of a perturbation function, generates multiple derived datasets from the input dataset 251, and returns the derived dataset with the highest utility score to a requestor computer 260.

The computer system 250 may be implemented within a cloud computing environment, such as a managed group of interconnected servers hosting a dynamic number of virtual machines, or with the use of general purpose processors or application specific integrated circuits (ASICs) or field programmable gate arrays (FPGAs). Parameters, values, variables etc. are stored as digital data in program memory or a separate volatile non non-volatile data memory.

FIG. 2a is to be understood as a blueprint for the software program and may be implemented step-by-step, such that each step in FIG. 2a is represented by a function in a programming language, such as C++ or Java. The resulting source code is then compiled and stored as computer executable instructions on program memory 255. In that sense, program memory comprises a data sharing module 257 that provides a derived dataset that protects the input dataset 251 from liking with further dataset 252.

Requestor computer 260 sends a request to custodian computer 253. To that end, requestor computer 260 also comprises a processor 264 and program memory 265. Processor 254 executes program code stored on program memory 265 to request a dataset from custodian computer 253. In some embodiments, the requestor computer 260 is registered with the custodian computer 253 and authenticates itself. Through this authentication process, the custodian computer 253 can determine that the requestor computer 260 satisfies a level of data protection. For example, requestor computer 260 has a proven ability to maintain any dataset confidential and to prevent linkage through access control, for example. In that case, the level of protection against linkage, as implemented by custodian computer 253 may be lower. In another example, requestor computer 260 is not authenticated so custodian computer 253 assumes that the aim of requestor computer 260 is to link the dataset with further data to re-identify records. In that case, the level of protection against linkage will be higher. In that sense, there is a rule based or tier based system that determines the level of protection based on the requestor. The level of protection may therefore be based on the request since the request may include the identity and accreditation status of the requestor computer 250.

### Identification of ID and Q Attributes

An attribute is considered an identifier attribute (ID) if each field of that attribute is unique, leading to a unique identification of each record of the input dataset, enabling direct linkability to sensitive information. If P_{uq} (refer to Equation 3) of a particular attribute is greater than the threshold uniqueness T_{uq} (e.g. 0.95), the processor considers that to be ID-attribute and removes it from the dataset. Hence, the lower the value of T_{uq}, the stricter the selection of ID attributes.

$${P}_{uq} = \frac{the total number of unique fields of an attribute}{the total number of records} \qquad ( 3 )$$

### Identifying Initial Tuple Distribution of the Dataset to Allow M Maintain the Data Distribution in QS

The disclosed methods applies Algorithm 1 below to generate a status label on the tuples that classifies them into a particular cluster after conducting mode imputation (mode imputation is used to accommodate both categorical and non-categorical data). This step enables the disclosed methods to identify the tuple distributions of the original dataset to allow M to produce a perturbed version that resembles the data distribution of the original dataset. In some embodiments, the processor uses the k-means algorithm and Silhouette analysis to identify the optimal clustering dynamic of the input dataset. This step is not used if the input dataset is a classification dataset and each tuple has a class label, as the class labels represent the tuple distribution.

Algorithm 1: Identifying original tuple
distribution of the input dataset

| | Input: | QS ← QS dataset |
|---|---|---|
| | | cn_range ← list of cluster numbers to be searched |
| | Output: | Tₛ ← tuple status |
| 1 | for each cn ∈ {cn_range} do | |
| 2 | \| | run k - means clustering on QS, where k = cn; |
| 3 | └ | s_{cn} = Silhouette Coefficient of cn; |

| | |
|---|---|
| 4 | select the cn of maximum(s_{cn}); |
| 5 | return Tₛ, which is the k - means cluster label of each tuple under |
| | maximum(s_{cn}); |

### Identification Q Attributes

A set of attributes that, in combination, can uniquely identify a record is called a quasi-identifier (Q), which also leads to easy linkability to auxiliary data, hence, with a potential threat of leaking private information.

### Declaring Q Attributes

Data-specific Q attribute selection is challenging as datasets from different domains can have different definitions for sensitive attributes. Hence, the sensitivity of a particular attribute depends on the context. A human data curator can accidentally categorize a sensitive attribute as one of the Q attributes if he/she has to select Q attributes every time the method works on a particular dataset. This can lead to an accidental privacy leak as an adversary can potentially link Q attributes to auxiliary knowledge revealing the original values of a certain person's corresponding S attributes.

This disclosure defines a global set of Q attributes (GQ attributes) that are generic, most frequent, and common to a particular domain (e.g. commonly used by the institution that uses this disclosure). This approach allows the selection of Q attributes common to different types of datasets and domains selectively, making the Q attribute selection simplified, automated and secured. At the same time, the selected Q attributes do not have unacceptable levels of indistinguishability within a given dataset.

Hence, the selected Q attributes are further refined by a process that extensively assesses the sensitivity of the selected Q attributes in terms of the personal information factor (PIF) metric defined below. It is noted here again that the PIF is indicative of the linkability of the input dataset.

### Cell Surprise Factor (CSF) and Personal Information Factor (PIF)

This disclosure defines a probabilistic measure named cell surprise factor (CSF), which is upper bounded by 1 and offers a way to reason about how the record indistinguishability is influenced by the participation of a particular attribute or a collection of attributes. The CSF of an attribute, A (or a collection of attributes) is calculated according to Equation 4. The posterior distribution (D^{P}) is the conditional probability distribution (refer to Equation 5) of the records of A given the second attributes (B) records (or a collection of attributes). Hence, the CSF reflects the change, or surprise, of the cell value alone, without interfering with the other elements in the posterior. Consequently, CSF distribution provides a good representation of a particular attribute's indistinguishability within D. If the attribute is indistinguishable, that also means it is difficult to link this attribute to external data. On the other hand, if the attribute is distinguishable, it makes it easier to link that attribute with other data.

Now, a personal information factor (PIF) is defined below to represent the CSF distribution of an attribute through one value which is bounded by [0,1].

$$Prior ( X ) = P ( X = x ) = \frac{\vert x \vert}{\vert X \vert} \qquad ( 4 )$$

$$Posterior ( X ) = P ( X = x \vert Y = y ) = \frac{\vert x , y \vert}{\vert y \vert} \qquad ( 5 )$$

Define,

$$CSF = Abs ( Prior ( X ) - Posterior ( X ) ) \qquad ( 6 )$$

Note that CSF is upper bounded by Posterior(X) as the method only looks at the increase in indistinguishability. Hence, in most examples, Prior(X)≤Posterior(X).

Let xᵢ be the csf value bins (bounded by [0,1]) of an attribute, where hᵢ is the number of occurrences of each xᵢ. Then,

$$PIF = \frac{{\sum }_{i = 1}^{n} {x}_{i} {h}_{i}}{{\sum }_{i = 1}^{n} {h}_{i}} \qquad ( 7 )$$

Again, it is noted that the PIF is a scaled or weighted version of the CSF. In other words, the CSF represents the difference between the prior (unconditional) probability of the attribute in relation to the posterior (conditional) probability of that attribute. The PIF represents a weighted combination of CSFs using the number of occurrences. Therefore, the PIF is also indicative of the linkability of the input dataset.

### Application of Perturbation on the QS-Dataset

The perturbation process of the QS-dataset is a four-step process:
(1) further assess the Q attributes using PIF,
(2) refine (update) the Q and S attributes based on the PIF analysis,
(3) determine the privacy requirements (ε and δ) of the S-dataset based on the PIF analysis, and
(4) conduct perturbation on S data and identify a locally optimal perturbed instance to be released.

In this sense, processor 254 partitions the input dataset into the Q partition and the S partition and applies the perturbation function only to the S partition.

### Further Assessing the Q Attributes Using PIF

This step first generates the PIF values of all Q attributes (QPIFᵢ, where i represents the i^{th} attribute) in the Q-dataset. Next, the PIF values of all Q attributes in the QS-dataset (QSPIFᵢ) are calculated to determine the effect of S attributes on each Q attribute. The difference between QPIFᵢ and QSPIFᵢ of a particular Q provides evidence of how independent its data distribution is from S attributes. An inequality, ΔPIFᵢ≥αQPIFᵢ can be employed to determine the change in PIF is α times the QPIFᵢ, where ΔPIFᵢ=QSPIFᵢ−QPIFᵢ and α is the sensitivity coefficient. Hence, maintaining α at 1 means that the PIF leak from Qᵢ in the QS dataset will increase by exactly QPIFᵢ. Since, QSPIFᵢ, QPIFᵢ>0, QSPIFᵢ>QPIFᵢ, and QSPIFᵢ≤1, we can take QSPIFᵢ−QPIFᵢ≤1. Since, 1≥QSPIFᵢ, QPIFᵢ≥αQPIFᵢ. Therefore, 1≤αQPIFᵢ. Consequently,

$$0 \geq α \geq \frac{1}{{QPIF}_{i}} ,$$

implying that α is unbounded above for the bounds, [0,1] of QPIFᵢ. Hence, it is possible to take α=1 (QPIFᵢ≥QPIFᵢ) to be more reasonable as it is the lowest α upper bound possible.

Besides, for this condition to be satisfied, QPIFᵢ<0.5 ought to be satisfied. Hence, the Q attributes which satisfy the inequality, ΔPIFᵢ≥QPIFᵢ are moved to the S-dataset for perturbation. Once this step is complete, the method calculates the PIF (PIFThresh) of the QS dataset as given in the Equation 8 to determine the privacy requirements of the S-dataset. In the equation, QSMaxPIF is the maximum PIF value returned by the QS dataset. QMaxPIF is the maximum PIF of the refined Q-dataset. As shown, the PIFThresh considers the overall PIF leak of the QS dataset as well as the additional PIF exposure caused by the Q data.

In another example, an initial step to determine the privacy requirements of the S-dataset, the method calculates the PIF (PIF_{Thresh}) of the QS dataset using the below Equation. In the equation, QSMaxPIF is the maximum PIF value returned by the QS dataset.

$${PIF}_{Thresh} = \{ \begin{matrix}QS Max PIF & if QS Max PIF < 1 \\ 1 & otherwise\end{matrix} \qquad ( 7 a )$$

### Developing a Link Between PIF and (ε,δ)

A link between PIF and (ε, δ) in terms of enforcing differential privacy can be modeled as follows: The definition of (ε, δ)-differential privacy characterizes the probabilistic bounds for a randomized algorithm or statistical mechanism M. For every pair of neighboring datasets d and d′ (that differ by a single individual's data) and for every possible subset of the output space S⊆Range(M), this model ensures that:

$$P [ M ( d ) ∈ S ] \leq {e}^{E} P [ M ( {d}^{′} ) ∈ S ] + δ \qquad ( 8 a )$$

where P[M(d)∈S] denotes the probability that the mechanism M produces an output in set S with input dataset d.

Here, ε signifies the privacy parameter (the privacy budget), and δ is a negligible quantity representing the probability of the privacy mechanism potentially violating the ε-privacy condition. As ε approaches zero and δ is sufficiently small, a higher degree of privacy protection is conferred. Hence, we can define a privacy metric f(ε,δ)=(1−exp(−ε))+δ, which serves as a suitable gauge for quantifying privacy levels. Consequently, a decrease in the value of f(ε, δ) indicates an enhanced privacy protection.

One property of differential privacy is its postprocessing invariance, implying that if a random mechanism M guarantees (ε,δ)-differential privacy, then any post-processing function g applied to the output of M also maintains the (ε, δ)-differential privacy. Formally, if M ensures (ε,δ)-differential privacy, then the composed mechanism gºM is also (ε,δ)-differentially private for all functions g.

In the non-interactive privacy-preserving data publishing paradigm, a data curator generates a differentially private version of a dataset D using a differentially private mechanism M. In this setting, f(ε,δ) acts as an upper bound for privacy loss, ensuring that privacy loss does not exceed (1−exp (−ε))+δ.

Examining a particular attribute A∈D, the “Personal Information Factor” (PIF_{A}) can be defined, which quantifies the attribute-specific distinguishability level. For each attribute A, Δ_{A} is defined as the increase in indistinguishability, which can be represented as:

$${Δ}_{A} = Posterior ( A ) - Prior ( A ) \qquad ( 9 a )$$

The relationship between PIF_{A} and Δ_{A} is given by:

$${PIF}_{A} = \frac{{\sum }_{i = 1}^{n} {Δ}_{{A}_{i}} {h}_{i}}{{\sum }_{i = 1}^{n} {h}_{i}} \qquad ( 10 a )$$

where Δ_{A}_{ᵢ} represents the increase in indistinguishability for the attribute A in the i-th bin with hᵢ occurrences.

Utilizing PIF_{A} for each attribute, the privacy measure f_{A} is introduced as follows:

$${f}_{A} ( {PIF}_{A} , δ ) = {PIF}_{A} + δ . \qquad ( 11 a )$$

Consequently, it is possible to derive a privacy measure for the entire dataset D using the maximum Personal Information Factor (PIF_{Thresh}) over all attributes in D. Hence, the privacy measure for the dataset can be defined as:

$${f}_{D} ( ε , δ ) = {PIF}_{Thresh} + δ . \qquad ( 12 )$$

f_{D}(ε, δ) signifies an upper bound to privacy loss upon the release of the dataset and provides a quantitative control mechanism balancing data utility and privacy protection. PIF_{Thresh}=max (PIF_{A}_{ᵢ}) signifies the maximum PIF across all attributes, indicating the dataset's potential to satisfy privacy parameters without any attribute surpassing this threshold. A fuzzy model can now be utilized to represent this relationship between PIF_{Thresh} and (ε,δ).

### Determination of the Privacy Parameters (ε and δ) for S-Dataset Perturbation

In this disclosure, the values of the parameters of the perturbation function are calculated based on the PIF. In particular, this disclosure uses a fuzzy inference system (FIS) to determine the bounds for ε and δ for the S-dataset based on PIF_{Thresh}. The higher values of PIF (PIF_{Thresh}), the higher the distinguishability of the QS dataset. Consequently, high values of PIF indicate that the S data needs high privacy, requiring a high level of perturbation. This disclosure provides a fuzzy inference system between PIF, ε, and delta to accommodate this relationship. All three fuzzy variables have three membership functions (LOW, MEDIUM, HIGH), representing three levels of value ranges. All three membership functions take the Gaussian shape and its range to accommodate a smooth transition from one membership level (function) to another, considering the greater range of values (refer to FIG. 1). The mean (μ) and standard deviation (σ) of LOW, MEDIUM, and HIGH are (μ=0, σ=1), (μ=0.5, σ=1), and (μ=1, σ=1), respectively.

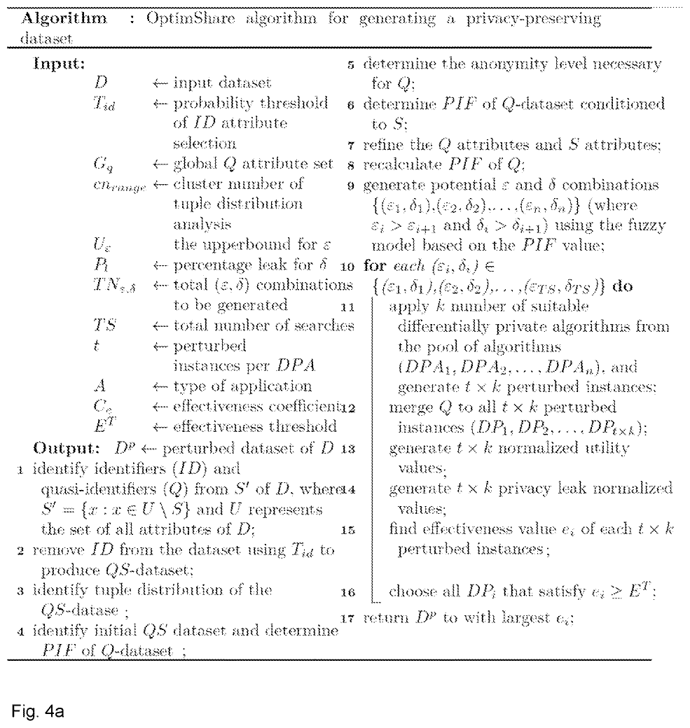

FIG. 3a represents the fuzzification of all three variables (ε, δ, and PIF). In this plot, the y-axis (degree of membership) quantifies the corresponding inputs (ε, δ) degree of membership. Next, the method sets the fuzzy rule base (a collection of linguistic rules), which provides the base for fuzzy inference. Equation 9 shows the rules of the proposed FIS. As shown in the equation, a rule is defined using IF-THEN convention (e.g. IF (ε=MEDIUM AND δ=HIGH) THEN (PIF=MEDIUM)). The rule evaluation step of the FIS combines the fuzzy conclusions into a single conclusion by inferencing the fuzzy rule base. In this step, MAX-MIN (OR for MAX and AND for MIN) operation is applied to the rules. The minimum between each membership level is considered for each rule, whereas the maximum fuzzy value of all rule outputs is used for the value conclusion.

$$\begin{matrix}0.7 & \begin{matrix}Rule 1 : IF ( ε = LOW ) THEN ( PIF = HIGH ) \\ Rule 2 : IF ( δ = LOW ) THEN ( PIF = HIGH ) \\ Rule 3 : IF ( ε = MEDIUM AND δ = \\ = MEDIUM ) THEN PIF = MEDIUM ) \\ Rule 4 : IF ( ε = HIGH ) THEN ( PIF = LOW ) \\ Rule 5 : IF ( δ = HIGH ) THEN ( PIF = LOW )\end{matrix}\end{matrix} \qquad ( 9 )$$

FIG. 3b depicts the rule surface between the three fuzzy variables. As shown in the rule surface, higher values of PIF correspond to lower values for ε and δ. The final step of the FIS is the defuzzification based on the rule aggregated shape of the output function. The method uses the centroid-based technique to obtain the final defuzzified output value, where x=output and μₓ=degree of membership of x. As depicted in the fuzzy-rule surface (refer to FIG. 3), a single PIF value corresponds to a collection of (ε,δ) combinations.

### Application of Perturbation on the S-Dataset

In some embodiments, the disclosed method conducts z-score normalization on the S-dataset before the perturbation to ensure that all S attributes are equally important and that the perturbation is normalized across the dataset. Next, the method generates the list of (ε and δ) combinations for the corresponding PIF_{Thresh} of the input dataset. For a given (ε and δ) choice, the method conducts perturbation over the S-dataset to produce a predefined number of perturbed instance resembling the data distributions provided herein. Each perturbed version is then min-max rescaled back to original attribute min max values and merged with the Q-dataset to produce perturbed QS datasets.

### Utility Analysis of Perturbed Instances

The utility can be measured based on any measurement such as accuracy, precision, recall, and ROC area (KL-divergence for generic scenarios) normalized within [0,1]. Take KLₓ to be the KL-divergence between an attribute, xᵢ^{p} ∈S of a perturbed instance, DPᵢ and the nonperturbed attribute, xᵢ of

$${x}_{i}^{p} .$$

The maximum of all KLₓ is considered the KL-divergence of the perturbed dataset, representing the highest distribution difference. Assume that the utility of the original input data on the corresponding application is Uₒ, and a particular perturbed instance produces an accuracy of Uₚ. In some cases, the data perturbation may improve the distributions of specific attributes enabling the perturbed data to produce more accuracy in certain instances. Considering this fact, we define utility loss Uₗ to measure the loss of utility by a perturbed dataset, as given in Definition 2.

Definition 2 (Utility loss-U_{g})

$${U}_{l} = \{ \begin{matrix}( {U}_{o} - {U}_{p} ) & if {U}_{o} > {U}_{p} \\ 0 & otherwise\end{matrix} \qquad ( 10 )$$

In another example, the utility is measured based on any measurement such as accuracy, precision, recall, and ROC area (KL-divergence for generic scenarios) normalized within [0,1]. Consider KLₓ as the KL-divergence between a perturbed attribute,

$${x}_{i}^{p} ∈ S ,$$

and it unperturbed version, xᵢ. The maximum KLₓ is the dataset's KL-divergence, indicating the highest distribution difference. The utility loss Uₗ quantifies the utility reduction resulting from data perturbation, given an original utility Uₒ and a utility Uₚ after the perturbation.

The effectiveness of perturbation is gauged by the normalized residual linkage leak P_{N} and the ε-threshold T_{ε} set by the OptimShare curator. The dataset is not suitable for release if P_{N} is too high, which is calculated as

$$\frac{ε L}{{T}_{ε}}$$

if T_{ε}>εL, or 1 otherwise, where L represents linkable records.

The effectiveness loss (Eₗ) of a perturbed dataset is defined as a weighted measure of Uₗ and P_{N}, calculated by Eₗ=CUₗ+(1−C) P_{N}. Here, C determines the emphasis on linkage protection (high C) versus utility preservation (low C). The ranges of Eₗ are dependent on P_{N} and Uₗ values: For Low P_{N} and Low Uₗ: Eₗ is in [0, C]. For High P_{N}, low Uₗ: Eₗ is in [C, 1]. For Low P_{N}, high Uₗ: Eₗ is in [1−C, 1]. For High P_{N} and High Uₗ: Eₗ is in [C, 1]. In our study, we set C to 0.5 to treat residual linkability leak and utility as equally important.

### Privacy Analysis

Once a perturbed instance of the input dataset is generated, the corresponding instance is checked for its vulnerability against data linkage risk by assessing the similarity between the tuples of original and perturbed instances. This disclosure provides a threat model that addresses the worst-case scenario of linkage risk by assuming that the attacker has full knowledge about the Q attributes in the perturbed QS-dataset.

### Threat Model:

The adversary has a complete knowledge (e.g. record order, attribute domain) of the Q attributes. This assumption leads to a worst-case linkage risk by enabling the adversary to explore the linkability of the records through Q attributes based on the tuple similarity. The knowledge gained will then be used by the adversary to derive the sensitive data of the individuals.

This disclosure defines a similarity group, SGₖ, to be a group of records in the QS dataset, where all Q records are the same. For each similarity group (SGₖ), the cosine similarity

$$( {CS}_{r}^{i} )$$

between the original S attributes and perturbed S attributes of each record (rᵢ) is taken. Now the worst-case record linkability is defined according to Definition 3.

### Definition 3 (Record Linkability)

Let R be the set of all rows in the perturbed (P) and original (D) datasets. If q^{α}=q^{β} for some α,β∈R and q∈Q, take (q^{α}, s^{α})∈SG. For each SGₖ ∈SG compute

$${CS}_{k}^{i}$$

for some i∈R_{SG}_{ₖ}, where R_{SG}_{ₖ} is all records in SGₖ. If CSₖⁱ≤CSₖ^{j}∀j␣R_{SG}_{ₖ}, then

$${CS}_{k}^{i} ∈ L ,$$

where L Is the set of linkable records.

For any α,β∈R such that q^{α}=q^{β} for some q∈Q, the probability that (q^{α}, s^{α}) and (q^{β},s^{β}) are in the same similarity group and (q^{α}, s^{α}) is linkable is small.

Proof. Consider D as an original dataset with n tuples and m attributes. Define S and Q as sets of sensitive and non-sensitive attributes in D respectively. Assume the adversary possesses complete knowledge of Q in perturbed dataset, D^{P}.

Record linkability can be defined as follows. Consider R as the collection of all records in D and D^{P}. If q^{α}=q^{β} for some q∈Q and α,β∈R, then (q^{α},s^{α}) and (q^{β},s^{β}) are part of the same similarity group, SG. Compute the cosine similarity,

$${CS}_{k}^{i} ,$$

between original and perturbed S attributes of each record rᵢ in SGₖ. A record is linkable if

$${CS}_{k}^{i} \leq {CS}_{k}^{j}$$

for all i∈R_{SG}_{ₖ}, for some j−R_{SG}_{ₖ}. Denote linkable records set as L.

ε-differential privacy is satisfied if for any datasets D₁ and D₂ differing by at most one record, and any outcome o of a randomized algorithm M, the following inequality holds:

$$\frac{P [ M ( {D}_{1} ) = o ]}{P [ M ( {D}_{2} ) = o ]} \leq {e}^{ε}$$

Take D₁ as the original dataset and D₂ as the dataset identical to D₁ but with modified sensitive attributes in one record. Then, ε-differential privacy can be applied, showing the adversary's successful record linkage probability is minimal.

Calculate the probabilities in the inequality's numerator and denominator. The numerator's probability is the chance that D^{P} contains a record (q^{α},s^{α}) in the same SG as (q^{β},s^{β}), and (q^{α},s^{α}) is linkable. This is:

$$P [ M ( {D}_{1} ) = o ] = P [ ( {q}^{α} , {s}^{α} ) ∈ SG ⋀ {CS}_{k}^{i} \leq {CS}_{k}^{j} ∀ j ∈ {R}_{S {G}_{k}} ]$$

For the denominator, the probability is the chance that D^{P} contains a record (q^{α},s^{β}) in the same SG as (q^{β},s^{β}), and (q^{α},s^{β}) is linkable:

$$P [ M ( {D}_{2} ) = o ] = P [ ( {q}^{α} , {s}^{β} ) ∈ SG ⋀ {CS}_{k}^{i} \leq {CS}_{k}^{j} ∀ j ∈ {R}_{S {G}_{k}} ]$$

Substituting into one of the previous equations provides:

$$\frac{P [ ( {q}^{α} , {s}^{α} ) ∈ SG ⋀ {CS}_{k}^{i} \leq {CS}_{k}^{j} ∀ j ∈ {R}_{S {G}_{k}} ]}{P [ ( {q}^{α} , {s}^{β} ) ∈ SG ⋀ {CS}_{k}^{i} \leq {CS}_{k}^{j} ∀ j ∈ {R}_{S {G}_{k}} ]} \leq {e}^{ε}$$

This suggests the adversary's successful record linking probability is limited, fulfilling the ε-differential privacy requirement.

The disclosed methods satisfies ε-differential privacy when the following inequality holds.

$$\frac{P [ ( {q}^{α} , {s}^{α} ) ∈ SG ⋀ {CS}_{k}^{i} \leq {CS}_{k}^{j} ∀ j ∈ {R}_{S {G}_{k}} ]}{P [ ( {q}^{α} , {s}^{β} ) ∈ SG ⋀ {CS}_{k}^{i} \leq {CS}_{k}^{j} ∀ j ∈ {R}_{S {G}_{k}} ]} \leq {e}^{ε}$$

Proof. The previous proof demonstrates that the numerator and denominator of a previous equation are small, indicating the probability of a record in a similarity group being linkable is minimal. This necessitates verifying that the perturbations on D^{P}'s sensitive attributes suffice to deter successful record linking by an adversary.

This is feasible by ensuring the cosine similarity between the original and perturbed sensitive attributes of all D^{P} records is minimal. Lower cosine similarity complicates record linking for the adversary as it dictates the record's linkability probability. Compliance with the privacy budget demands a negligible change in a specific outcome's probability when a record is added or deleted, which is achievable by applying D^{P} noise to sensitive attributes during perturbation.

The sufficiently small cosine similarity between original and perturbed attributes can be upper-bounded using record linkability (Definition 3), computing the cosine similarity for each dataset record. Complying with the privacy budget involves bounding the change in a specific outcome's probability upon record addition or deletion.

Considering two records, (q₁,s₁) and (q₂,s_{1′}), which have identical quasi-identifiers, and sensitive attributes s₁ and s_{1′}, (where s_{1′}, is the perturbed version of s₁, generated using an (ε,δ)-differentially private generator), the cosine similarity of original and perturbed sensitive attributes can be computed, showing the insignificant change in a specific outcome's probability with record addition or deletion.

The cosine similarity between s₁ and s_{1′} is calculated as:

$$CS = \frac{{s}_{1} \cdot {s}_{{1}^{′}}}{\vert {s}_{1} \vert \vert {s}_{{1}^{′}} \vert}$$

The Cauchy-Schwarz inequality can be used to show that:

$${s}_{1} \cdot {s}_{{1}^{′}} \cdot < \vert {s}_{{1}^{′}} \vert \vert {s}_{{1}^{′}} \vert$$

Given the constraints set by

$$\frac{ε L}{{T}_{ε}}$$

(where L represents the set of linkable records), an upper bound for |s_{1′}| can be established to ensure that the cosine similarity is small.

For

$$\frac{ε L}{{T}_{ε}} \leq 1 ,$$

the added noise can be ensured to be within the acceptable range defined by ε. This limits the denominator of the cosine similarity expression to a value that's consistent with the privacy budget, ε.

Therefore, the cosine similarity between the original and perturbed sensitive attributes is upper-bounded by a value that complies with the privacy budget ε, which confirms that the disclosed methods satisfies ε-differential privacy.

### The Effectiveness Analysis of Perturbation and Thresholding

Take T_{ε} to be the threshold ε set by the curator. The normalized privacy leak P_{N} is defined according to Equation 11. If P_{N}, the corresponding dataset is not considered for release.

$${P}_{N} = \{ \begin{matrix}\frac{ε \vert L \vert}{{T}_{ε}} & if {T}_{ε} > ε \vert L \vert \\ 1 & otherwise\end{matrix} \qquad ( 11 )$$

which means the disclosed method selectively blocks outputting the derived dataset upon determining that the weighted sum of utility loss and privacy leak is above a predetermined threshold.

The effectiveness loss (Eₗ) of a perturbed dataset is defined as a weighted metric of normalized privacy leak and utility loss as given in Equation 12. In one example, C is set at 0.5, treating both leak (based on linkability) and utility equally.

$${E}_{l} = C {U}_{l} + ( 1 - C ) {P}_{N} \qquad ( 12 )$$

### Proposed Algorithm

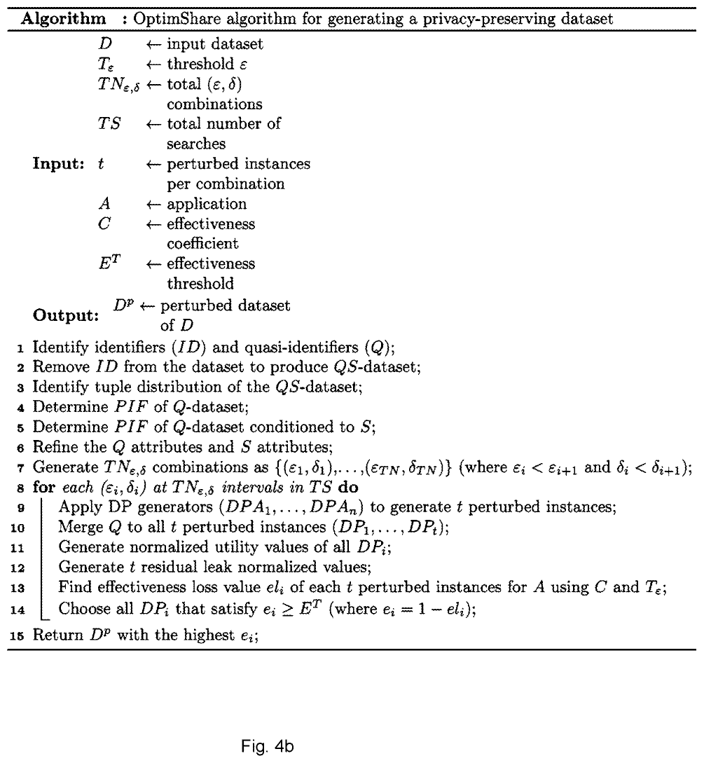

FIGS. 4a and 4b illustrate examples of an Algorithm as the algorithmic flow of steps in producing privacy-preserving (perturbed) datasets. It shows how the disclosed method integrates the steps mentioned in the previous sections in producing the privacy-preserving datasets.

### Results

This section empirically shows how the disclose method derives an optimally perturbed privacy-preserving dataset is released. First, we show the dynamics intermediate steps followed by the dynamics of multiple perturbed instances of an input dataset. For this experimental evaluation, we used a MacBook pro-2019 computer with an MI Max and 32 GB of RAM for the experiments on datasets. For datasets with a larger numbers of tuples, we used one 112 Dual Xeon 14-core E5-2690 v4 Compute Node (with 256 GB of RAM) of CSIRO Bracewell HPC cluster.

TABLE 1
Datasets used for the experiments

| | | Number of | Number of | Number |
|---|---|---|---|---|
| Dataset | Abbreviation | Records | Attributes | of Classes |
| NHANES diabetes | NHDS | 4412 | 17 | 2 |
| Kagglehttps://www.kaggle.com/cdc/nationa | | | | |
| l-health-and-nutrition-examination-survey | | | | |
| Wine | WQDS | 4898 | 12 | 7 |
| Qualityhttps://archive.ics.uci.edu/ml/dataset | | | | |
| s/Wine+Quality | | | | |
| Page Blocks Classification | PBDS | 5473 | 11 | 5 |
| https://archive.ics.uci.edu/ml/datasets/Page | | | | |
| +Blocks+Classification | | | | |
| Letter | LRDS | 20000 | 17 | 26 |
| Recognitionhttps://archive.ics.uci.edu/ml/d | | | | |
| atasets/Letter+Recognition | | | | |
| Statlog | SSDS | 58000 | 9 | 7 |
| (Shuttle)https://archive.ics.uci.edu/ml/datas | | | | |
| ets/Statlog+%28Shuttle %29 | | | | |
| Credit Score | CSDS | 150,000 | 11 | 2 |
| Kagglehttps://www.kaggle.com/c/GiveMeS | | | | |
| omeCredit/data?select=cs-training.csv | | | | |

### Configurations During Experiments

During the experiments, we set the primary parameters of the algorithm with the following values. T_{id}=0.95, G_{q}=[‘postcode’, ‘state’, ‘country’, ‘BPQ020’, ‘RIAGENDR’, ‘ALQ120Q’, ‘LBXTC’, ‘Pregnancies’, ‘Age’, ‘Gender’], cn_{range}=[2, 3, 4, 5, 6, 7, 8], Uₑ=8, Pₗ=0.01%, TN_{ε,δ}=12, TS=4, t=4, A=“classification-GaussianNB”, Cₑ=0.5, E^{T}=0.8. These settings were kept constant throughout all experiments to maintain a uniform experimental setting for unbiased results. DP-WGAN (private Wasserstein GAN using noisy gradient descent moments accountant) was used as the data perturbation technique for S data perturbation.

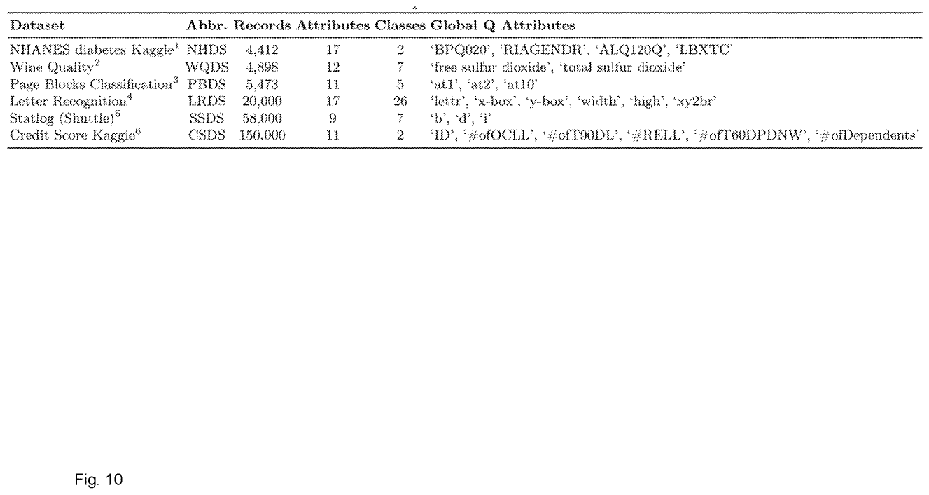

In other experiments, the primary parameters were set as follows: Tₑ=8, Pₗ=0.01% (δ=(1/(100×numberofrowsofD)))×Pₗ), TN_{ε,δ}=12, t=4, A=“classification—GaussianNB”, C=0.5, E^{T}=0.5. Global Q attributes used for each dataset are provided in FIG. 10. All settings remained constant in all experiments, ensuring uniformity for unbiased results. DP-WGAN (focusing non-categorical attributes) and PrivatePGM (focusing categorical attributes) were used for S data perturbation.

### Dynamics of Intermediate Algorithmic Steps

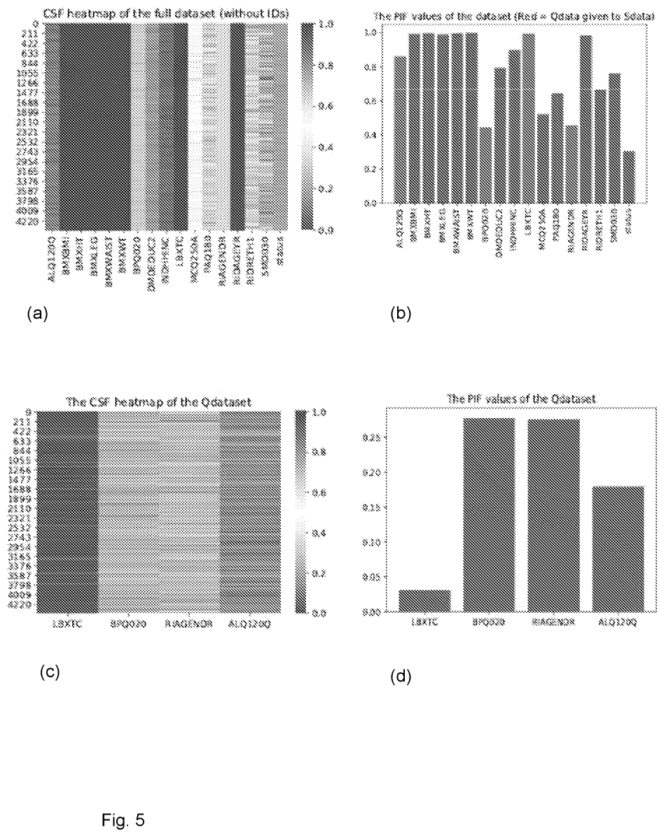

This section evaluates the experimental dynamics of the different thematic sections to understand the underlying process of developing a privacy-preserving dataset for release. As discussed above, one of the components of the disclosed method is the determination of privacy requirements. This is done through PIF analysis, as explained above. As shown in FIG. 5a, the input dataset shows extreme CSF values (represented by dark) in certain attributes (e.g. BMXBMI, BMXHT), whereas certain other attributes such as BPQ020 shows lower CSF values (represented by light). This is due to the introduction of BMXBMI drastically reducing the overall indistinguishability of the tuples in the dataset. However, BPQ020, among other attributes in the dataset, has much less impact on reducing the tuple indistinguishability. Hence, the comparison between FIG. 5a and FIG. 5b provides a clear indication to the intuition behind the PIF value generation. As shown in FIG. 5b, higher PIF values indicate higher levels of distinguishability (or PIF leak) compared to the other attributes.

As shown in FIGS. 5a and 5b, the separate analysis on the Q attributes provide a better understanding of them producing PIF values compared to them being introduced to the S attributes, as represented by the red bars in FIG. 5b. It is clear that PIF values of the attributes LBXTC and ALQ120Q drastically increase when they are introduced to the S attributes.

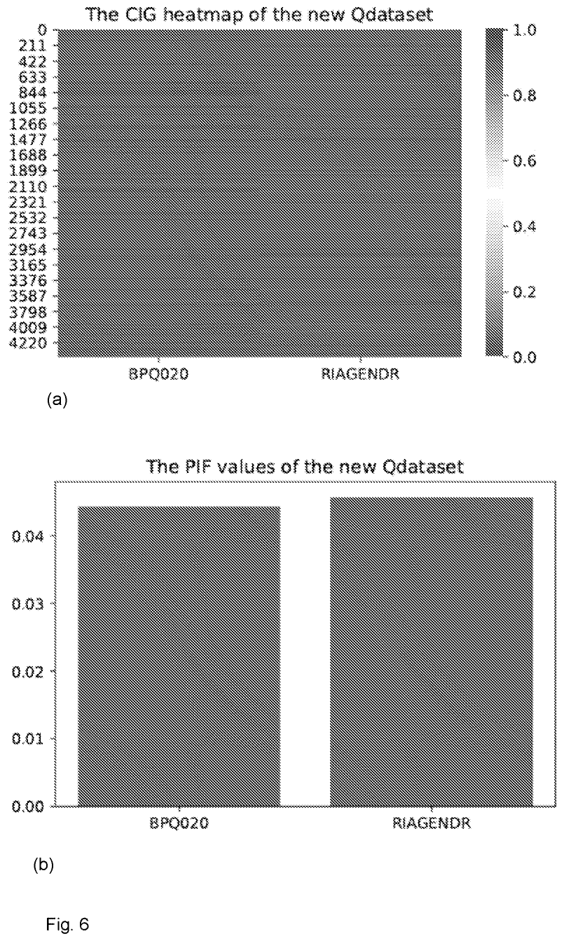

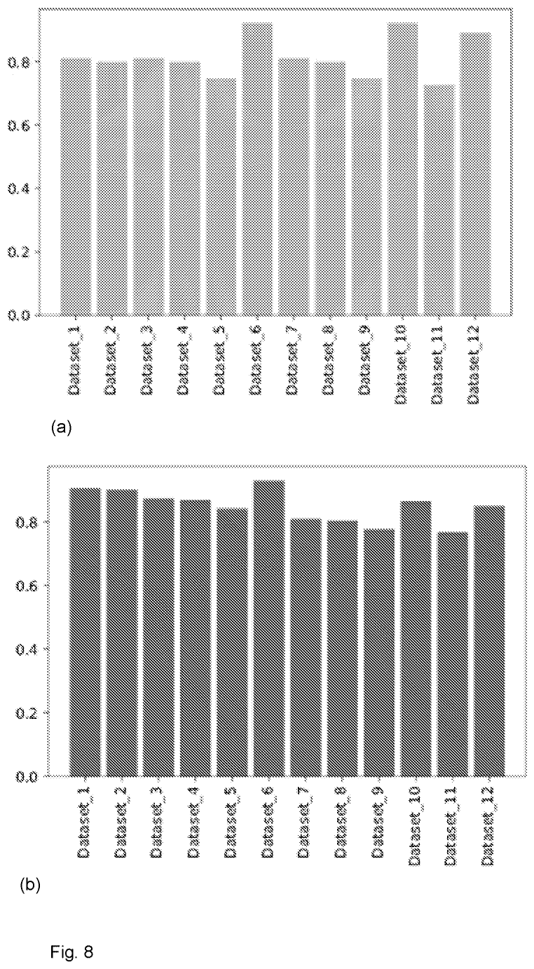

FIG. 8 shows the CSF and PIF dynamics of the refined set of Q attributes. As depicted by the plots, the disclosed method has identified that LBXTC and ALQ120Q should be removed from the set of Q attributes as they leak too much information to be released without any perturbation. Hence, LBXTC and ALQ120Q are automatically considered as sensitive attributes and moved to the set of S attributes. As shown in the plots (refer to FIGS. 6, 5a, and 5b) the refined Q attributes show minimal data distinguishability producing more homogeneity in the refined Q-dataset tuples. This result, in turn, supports the application of less perturbation on the S-dataset compared to the previous non-refined Q attribute set.

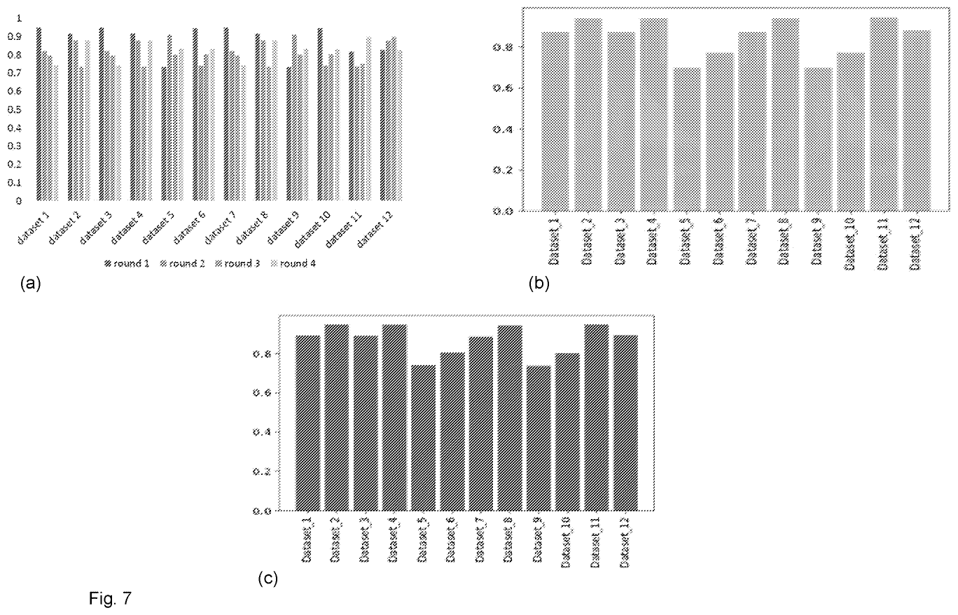

FIG. 7 shows the utility and effectiveness variations of the 12 datasets produced for the 12ε,δ combinations (TNε,β=12). As FIGS. 7a and 7b show, the utility, and effectiveness of the dataset are almost similar. This is due to the corresponding datasets producing much lower normalized privacy leak (P_{N}) than the utility values. This also suggests that the disclosed methods effectively refined the Q attribute so the datasets can still maintain a lower privacy leak. We forced the disclosed methods to stop refining Q attributes to investigate the dynamics of the utility and privacy of the privacy-preserving datasets.

FIG. 8 shows that the effectiveness dynamics are different from the utility dynamics. This is because the datasets tend to leak more information in certain scenarios due to the high PIF leaks from all Q attributes together, as identified previously. Now, the P_{N} has more impact on the effectiveness evaluation of the generated datasets: hence, the effectiveness plots show a comparably different pattern, as shown in FIG. 5.

FIG. 7 shows the utility variation of the intermediate datasets produced under 4 different rounds of data perturbation. According to the bar graph, it is clear that the utility is not stable and changes under different rounds of perturbation. This proves the importance of a systematic framework as disclosed herein in determining the best version of the dataset to release by considering multiple factors such as utility and privacy.

### Implementation

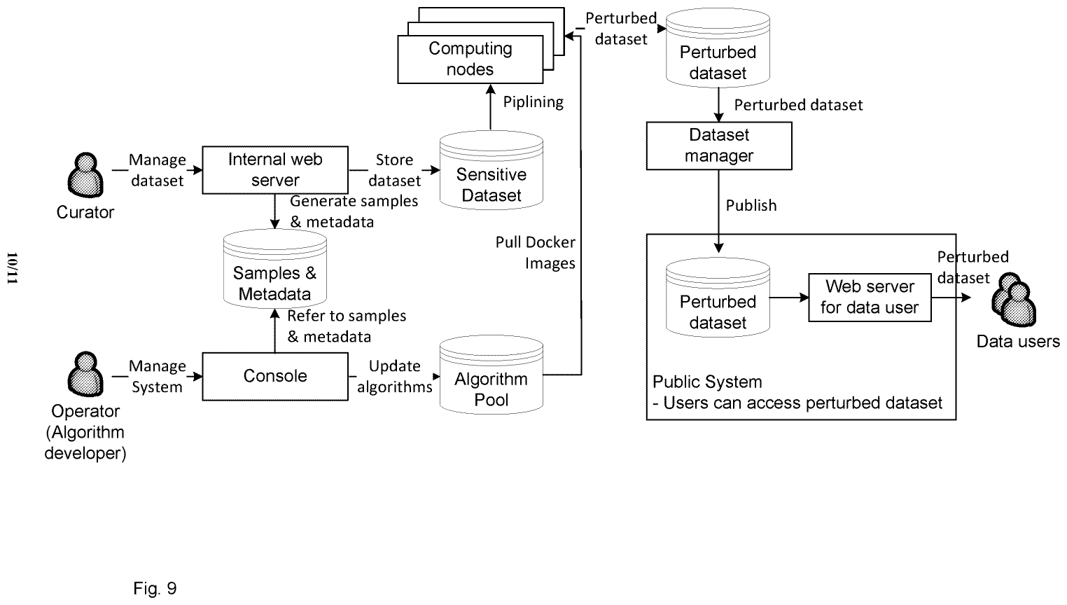

Two versions of the disclosed method were implemented (using PNthon 3.8): a server-based for large-scale settings and a stand-alone for single-computer use. FIG. 9 outlines a server-based system design with three user roles: curator (the data custodian), operator (admin), and data user, each with distinct privileges. Curators own and manage original datasets, applying data perturbation, auditing, and publishing perturbed datasets for data users. Operators, as administrators, manage the algorithms while being restricted from accessing the original datasets. Data users consume the perturbed datasets approved by curators. The system ensures security and data privacy by allowing dataset owners exclusive control and isolating servers from external access. This implementation uses Docker containers to store the privacy-preserving algorithm for scalability and continuous integration and deployment (CI/CD). The dataset manager then pushes the published datasets to the public system, where data users can only access approved, perturbed datasets.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer-implemented method for protecting an input dataset against linking with further datasets, the method comprising:
calculating multiple values of one or more parameters of a perturbation function, the perturbation function being configured to perturb the input dataset to protect the input dataset against linking with further datasets, each of the multiple values of the one or more parameters of the perturbation function indicating a level of protection against linking with further datasets;
generating multiple derived datasets from the input dataset, wherein
each of the multiple derived datasets are generated by applying the perturbation function to the input dataset, and
each of the multiple derived datasets are generated by using a different one of the multiple values of the one or more parameters of the perturbation function;
calculating, for each of the multiple derived datasets, a utility score that is indicative of a utility of the derived dataset for a desired data analysis; and
outputting one of the multiple derived datasets that has the highest utility score.

2. The method of claim 1, wherein:
the method further comprises receiving a request for the dataset from a requestor; and
the level of protection is based on one or more of the requestor or data in the request.

3. The method of claim 1, wherein calculating the multiple values of the one or more parameters of the perturbation function is based on a factor (PIF) indicative of linkability of the input dataset.

4. The method of claim 3, wherein the method further comprises:
calculating multiple cell surprise factors (CSF), each CSF representing an attribute's indistinguishability within the input dataset; and
calculating the factor indicative of linkability of the input dataset by combining the multiple CSFs.

5. The method of claim 4, wherein the method further comprises:
partitioning the input dataset into a first partition of quasi-identifiers and a second partition of sensitive data;
wherein the perturbation function is applied only to the second partition.

6. The method of claim 5, wherein the method further comprises:
calculating the factor indicative of linkability for the second partition including one attribute of the first partition;
based on the calculated factor, selectively adding the one attribute of the first partition to the second partition;
wherein the perturbation function is applied only to the second partition including selectively added attributes from the first partition.

7. The method of claim 4, wherein the method further comprises performing fuzzy interference using the factor indicative of linkability of the input dataset to determine the multiple values of the one or more parameters.

8. The method of claim 7, wherein performing the fuzzy interference is based on a fuzzy membership function for each of the factor indicative of the linkability and the one or more parameters of the perturbation function.

9. The method of claim 1, wherein linkability is measured in terms of differential ε, δ privacy and the one or more parameters of the perturbation function are ε and δ.

10. The method of claim 1, wherein the method further comprises removing identifier attributes from the input dataset.

11. The method of claim 1, wherein calculating the utility score comprises:
calculating a distribution difference between the input dataset and the derived dataset; and
outputting the one of the multiple derived datasets that has the highest distribution difference.

12. The method of claim 1, wherein calculating the utility score comprises:
calculating an accuracy of the desired data analysis on the derived dataset; and
outputting the one of the multiple derived datasets that has the highest accuracy.

13. The method of claim 1, wherein the method further comprises:
applying a threat model to the derived dataset that has the highest utility score and assessing the similarity between tuples of the input dataset and the derived dataset; and
selectively blocking the outputting based on the assessing the similarity.

14. The method of claim 1 wherein calculating the utility score is based on a utility loss and a privacy leak.

15. The method of claim 12, wherein the utility score is a weighted sum of utility loss and privacy leak.

16. The method of claim 12, wherein the method selectively blocks outputting the derived dataset upon determining that the weighted sum of utility loss and privacy leak is above a predetermined threshold.

17. A non-transitory computer-readable medium with program code stored thereon that, when executed by a computer, causes the computer to perform the method claim 1.

18. A computer system comprising a processor programmed to perform the method of claim 1.
